(19) United States
(12) Patent Application Publication
(10) Pub. No.: US 2014/0054344 A1
(43) Pub. Date: Feb. 27, 2014

(54) TIRE CARRIER

(71) Applicant: Cliff Watkins, Des Moines, IA (US)

(72) Inventor: Cliff Watkins, Des Moines, IA (US)

(21) Appl. No.: 13/972,416

(22) Filed: Aug. 21, 2013

Related U.S. Application Data
(60) Provisional application No. 61/691,397, filed on Aug. 21, 2012.

(51) Int. Cl. B62D 43/02

(52) U.S. Cl. CPC B62D 43/02
USPC 224/519

(57) ABSTRACT

The invention is directed to apparatuses and methods of use of tire carriers. The tire carriers of the present invention attach to a vehicle's hitch receiver and secure a spare tire on the rear exterior of the vehicle as opposed to within the rear cargo area or under the vehicle. In a particular embodiment, the tire carrier of the present invention is capable of rotating about a horizontal axis. In a further embodiment, the tire carrier of the present invention comprises a secondary hitch receiver and is thereby capable of hauling a trailer or other device that attaches via a hitch.

### CROSS-REFERENCE TO RELATED APPLICATIONS

This application claims priority and is related to U.S. Provisional Application Ser. No. 61/691,397, filed on Aug. 21, 2012. The entire contents of Provisional Patent Application Ser. No. 61/691,397 are hereby expressly incorporated herein by reference in their entirety including, without limitation, the specification, claims, and abstract, as well as any pictures, figures, tables, or drawings thereof.

### FIELD OF THE INVENTION

The invention relates generally to the field of automobile accessories. More particularly, but not exclusively, the invention relates to an after-market accessory for an automobile to aid in preserving the storage space of the automobile.

### BACKGROUND OF THE INVENTION

Automobiles, especially sport utility vehicles (SUVs) have some conflicting purposes. For example, vehicles are becoming more sleek and fuel-efficient, while also providing enough storage for the variety of uses of the vehicle. While cars have trunks to increase the storage space, SUVs do not. Instead, SUVs include compartments generally at the rear of the vehicle, which comprise an open space between the floor and the roof of the vehicle. The compartment is accessed either through the interior of the vehicle, or by opening one or more rear doors.

However, as consumers would like the storage compartments to have the most available space possible, sacrifices have been made. Spare tires have had to be removed from the storage compartment to increase the amount of space. The spare tires have generally been placed under the vehicle, in the floor of the storage space, or attached to the exterior of the vehicle at the rear.

Having the spare tires either under the vehicle or in the floor of the storage compartment creates problems. It can be very difficult to access the tires at these locations, especially when they are needed. If the storage compartment has been filled with items, they would all have to be removed in order to access the spare tire within the floor. Once the tire has been changed, the tire and all of the items must be re-added to the compartment, which is time consuming. The removal and replacing of the items also increases the chance that items may become damaged or lost.

Likewise, when the spare tire is positioned underneath the vehicle, the tire can be difficult to access. Generally, a lever or thread must be accessed in order to release the spare tire from a holding device under the vehicle. This could require one or more individuals to go below the vehicle, which may not be possible in certain situations. Furthermore, having the spare tire beneath the vehicle may cause the tire to become damaged during normal operation of the vehicle, with the driver unaware of any such damage.

In either case where the spare tire is housed underneath the vehicle or within the floor of the vehicle, the space for a spare tire is limited. The vehicle manufacturer has included the minimum amount of space to house and store a stock spare tire. Thus, if a vehicle owner has replaced the stock tires with larger tires, or replaced the stock rims provided for the tires, the space may not be large enough to house a spare tire.

Therefore, many vehicles include a device for mounting a tire on the exterior of an SUV or vehicle. The mounting devices are positioned at the rear of the vehicle, and generally include an assembly mounted to one side of the rear of the vehicle. The assembly includes a pivot point at this mounting location, with arms and a tire holding mechanism extending from the pivot point and towards the center of the rear of the vehicle. The assembly allows for the tire holding mechanism to be rotated about the pivot point towards the side of the vehicle in order to allow for access to the door handle to access the storage compartment at the rear of the vehicle.

However, this type of mechanism has many weak points due to the design of the mechanism. As the tire is mounted a distance generally 90° to the vertical, stress builds on the arm. Furthermore, the design of the tire holding mechanism is permanent to a vehicle, and cannot be removed and used with another vehicle. One would not be able to use such a mechanism to free up space in another vehicle.

Therefore, there is a need in the art for an apparatus to attach a spare tire to a vehicle that provides for the greatest amount of storage space within the vehicle, while also being easy to access. There is also a need in the art for a spare tire holder that can be used with numerous vehicles, and exchanged between the vehicles with ease.

### SUMMARY OF THE INVENTION

It is therefore a primary object, feature, and/or advantage of the present invention to provide an apparatus that overcomes the deficiencies in the art.

It is another object, feature, and/or advantage of the present invention to provide a tire carrier that can be inserted into an existing hitch of a vehicle.

It is yet another object, feature, and/or advantage of the present invention to provide a tire carrier that attaches to the hitch of a vehicle.

It is still a further object, feature, and/or advantage of the present invention to provide a tire carrier that rotates about a horizontal axis to move out of the way of a door.

It is still another object, feature, and/or advantage of the present invention to provide a tire carrier that can hold any size spare tire.

It is yet another object, feature, and/or advantage of the present invention to provide a tire carrier that includes a secondary hitch to allow the hookup of a trailer.

These and/or other objects, features, and advantages of the present invention will be apparent to those skilled in the art. The present invention is not to be limited to or by these objects, features and advantages. No single embodiment need provide each and every object, feature, or advantage.

### BRIEF DESCRIPTION OF THE DRAWINGS

FIG. 1 is a side view of the rear of a vehicle with an embodiment of the tire carrier of the present invention connected to the vehicle and having a spare tire mounted thereon in the transport position with a step connected to the secondary hitch receiver.

FIG. 2 is a rear perspective view of an embodiment of the tire carrier of the present invention connected to a vehicle and having a spare tire mounted thereon in the transport position with a step connected to the secondary hitch receiver.

FIG. 3 is a rear view of a vehicle with an embodiment of the tire carrier of the present invention connected to the vehicle and having a spare tire mounted thereon in the transport position with a step connected to the secondary hitch receiver.

FIG. 4 is a side view of the rear of a vehicle with rear cargo window open and with an embodiment of the tire carrier of the present invention connected to the vehicle and having a spare tire mounted thereon in a position lowered along the horizontal axis with a step connected to the secondary hitch receiver.

FIG. 5 is a side view of the rear of a vehicle with rear compartment door open and with an embodiment of the tire carrier of the present invention connected to the vehicle and having a spare tire mounted thereon in a position lowered along the horizontal axis with a step connected to the secondary hitch receiver.

FIG. 6 is a perspective view of an embodiment of the hitch connector of the tire carrier of the present invention connected to the vehicle hitch receiver in the transport position and with a step connected to the secondary hitch receiver.

FIG. 7 is a perspective view of an embodiment of the first, second, and third portions of the arm of the tire carrier of the present invention.

FIG. 8 is a top plan perspective view of an embodiment of the tire carrier of the present invention connected to the vehicle hitch receiver in the transport position and with a step connected to the secondary hitch receiver.

FIG. 9 is a rear perspective view of an embodiment of the tire carrier of the present invention connected to the vehicle hitch receiver in the transport position and with a step connected to the secondary hitch receiver.

FIG. 10 is a perspective view of an embodiment of the tire carrier of the present invention connected to the vehicle hitch receiver in the transport position.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The present invention relates to apparatuses for storing and carrying a spare tire. The tire carriers of the present invention have many advantages over existing methods and apparatuses for storing and carrying a spare tire. For example, the invention removes the spare tire from within a compartment of the vehicle, thereby freeing more storage space within the vehicle and ensuring easier access to the spare tire, particularly if the rear compartment is packed. The location is also advantageous compared to spare tires stored underneath vehicles, as those can be difficult to access. A further advantage of the present invention is that in particular embodiments it includes a secondary hitch receiver, thereby permitting the vehicle to haul a trailer or add anything else that connects to a hitch receiver. The present invention also has advantages over spare tire carriers that are horizontally affixed to the vehicle in that it is more structurally stable due to its upright configuration, while maintaining easy access to the rear of the vehicle due to the pivot point.

The embodiments of this invention are not limited to particular tire carriers and/or vehicles, which can vary and will be understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise.

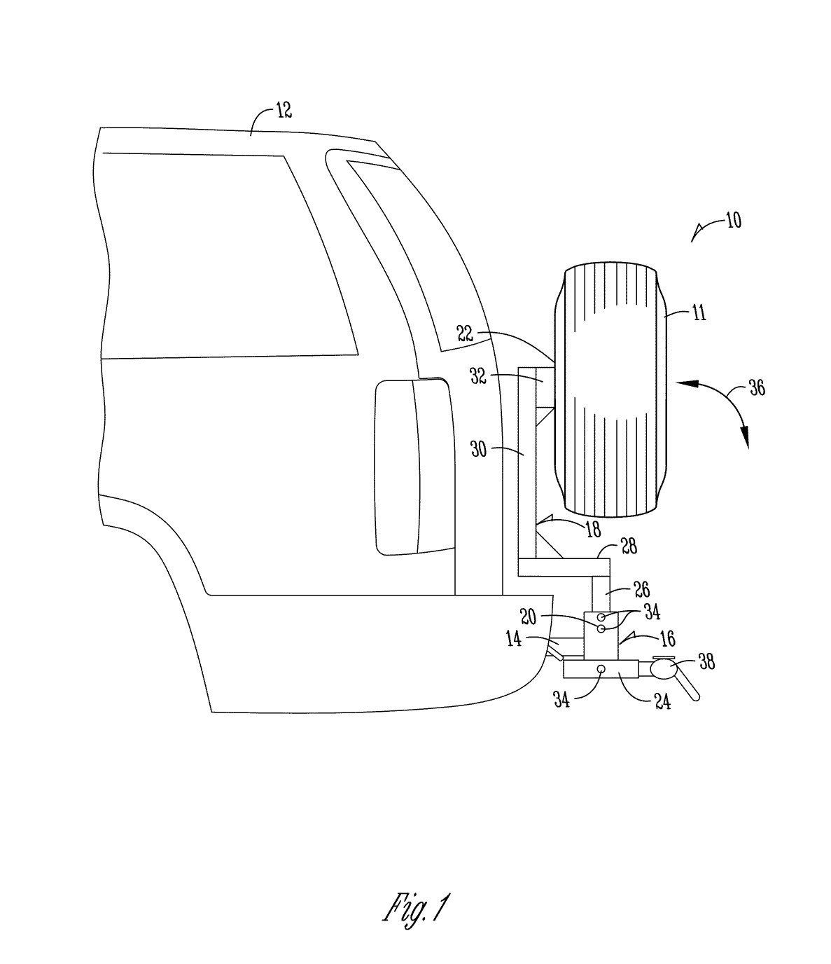

FIG. 1 shows the tire carrier 10 of the present invention connected to a vehicle 12 and having a spare tire 11 connected or mounted thereon. The tire carrier 10 of the present invention allows for a user to mount a spare tire to the exterior of a vehicle 12, thus saving vital storage space within the vehicle 12. Furthermore, the tire carrier 10 attaches to the vehicle 12 via the hitch receiver 14 of the vehicle 12. By attaching to a standard hitch receiver 14 of a vehicle 12, the tire carrier 10 of the present invention may be transferrable between different vehicles. Thus, a standard tire or spare tire 11 on the tire carrier 10 may be used in conjunction with almost any number of vehicles.

The tire carrier 10 attaches to the hitch receiver 14 of the vehicle 12 with a hitch connector 16. The hitch connector 16 is the general support member of the tire carrier 10. The hitch connector 16 is a generally metal member having an arm portion that extends into the hitch receiver 14 of the vehicle 12. A pin 34 or other locking member is then inserted and extended through apertures through both the hitch connector 16 and the hitch receiver 14 to lock the hitch connector 16 in place. The hitch connector 16 also includes a pivot point 20. Connected to the pivot point 20 is an arm 18.

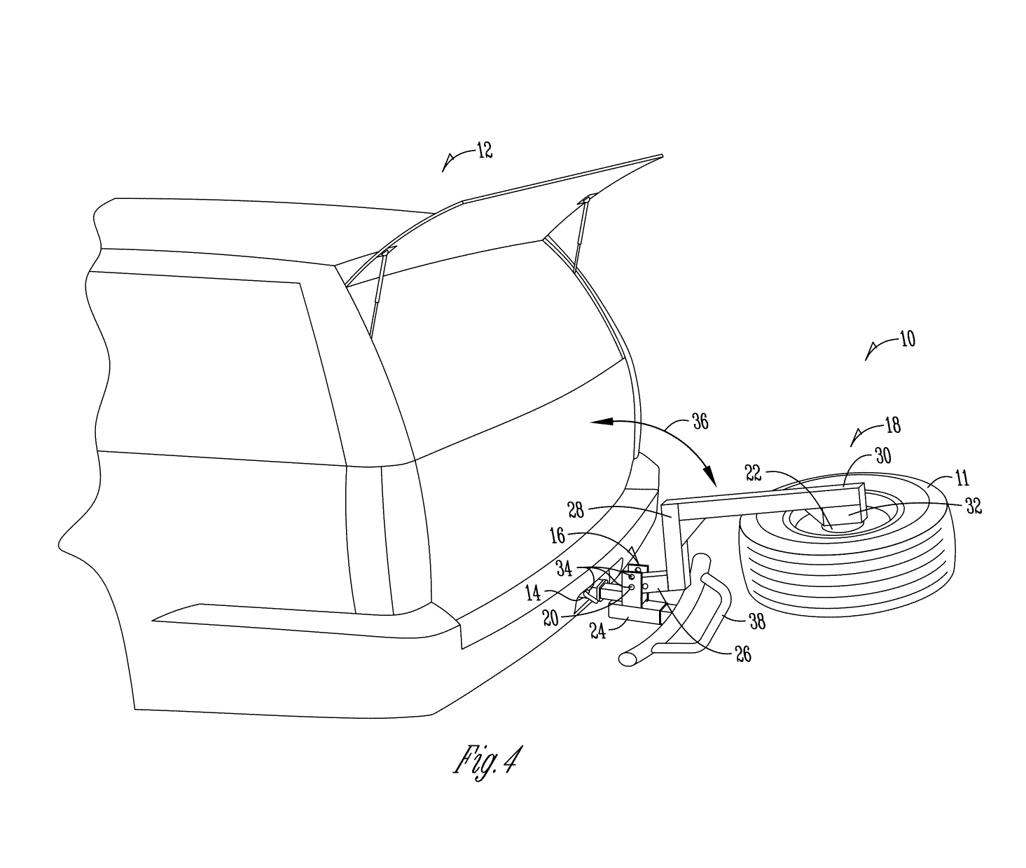

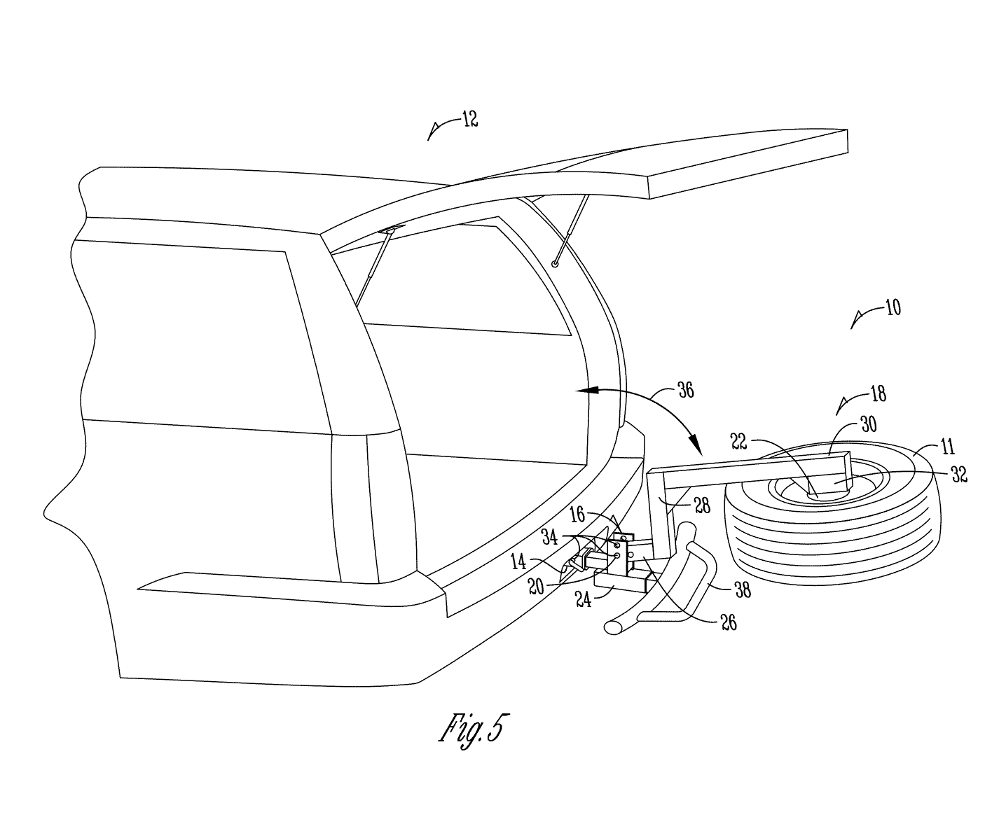

The arm 18 extends from the hitch connector 16 at the pivot point 20. The arm 18 is connected to the hitch connector 16 at the pivot point 20 via a pin or other locking member extending through the hitch receiver 14 and the arm 18. Furthermore, the hitch receiver 14 and arm 18 may also include another aperture through which a pin 34 may be placed to lock the arm 18 in a position to prevent the arm 18 from rotating about an axis through the pivot point 20. When the locking pin 34 is removed, the arm 18 may be rotatable about the pivot point 20 in the directions shown generally by the arrow 36 in FIGS. 1, 2, 4, and 5. Thus, the tire carrier 10 can be rotated about a generally horizontal axis at the pivot point 20 to move the spare tire 11 and the arm 18 out of the way of the rear door or doors of the vehicle 12. Once the access to the vehicle 12 has been finished, the tire carrier 10 can be rotated to a generally upright position for transport.

The arm 18 includes a first portion 26, a second portion 28, a third portion 30, and a fourth portion 32. The portions of the arm 18 may comprise a tubular steel; however, it should be appreciated that other shapes and types of materials may be used. The material should be rigid enough such that it is able to hold a spare tire 11 in the general upright position shown in FIG. 1. Furthermore, the tubular sections of the arm portions 26, 28, 30, 32 are affixed to one another. According to an embodiment of the invention, the tubular portions of the arm 26, 28, 30, 32 are welded to one another at generally 90° angles. Furthermore, between the second portion 28 and the third portion 30, as well as between the third portion 30 and the fourth portion 32, brace or support members may be included to increase the strength of the arm 18. These supports may be positioned at the 90° portion of the arms. Furthermore, at one end of the fourth portion 32 is a tire connector 22. The tire connector 22 is a member for receiving a spare tire 11 and securing the spare tire 11 to the arm 18. Thus, the tire connector 22 may be a variety of structures. For instance, the tire connector 22 may include fingers that attach to the lug nut holes of the rim of the spare tire 11. Alternatively, the tire connector may attach to the center of the spare tire 11. It should be appreciated that the present invention contemplates that the tire connector 22 includes generally any method for securing a tire 11 to the arm 18 such that the tire will stay secure during transport and movement or rotation of the tire carrier 10. Moreover, in particular embodiments of the invention, the tire connector 22 includes generally any method for securing other items to the arm 18 such that any particular item will stay secure during transport and movement or rotation of the tire carrier 10. Examples of other items that can be secured by the tire connector 22, include, but are not limited to, bicycles, storage containers, water skis, surfboards, snow skis, and snowboards. Those of skill in the art will be apprised of the type of connection necessary to secure various items and can appropriately secure other items.

Connected to the hitch connector 16 and shown generally below the hitch connector 16 is a secondary hitch receiver 24. As mentioned, the tire carrier 10 is connected and secured to the vehicle 12 via the vehicle's hitch receiver 14. Thus, the tire carrier 10 would prevent the attachment of a trailer or other device via the hitch receiver. Therefore, the addition of the secondary hitch receiver 24 allows for a vehicle to include both the tire carrier 10 and a free hitch. This provides the ability to attach a trailer, step 38, or other device. The secondary hitch receiver 24 is secured to the hitch connector 16 via welding in an embodiment. However, the secondary hitch receiver 24 may also be attached via pins 34 such that the secondary hitch receiver 24 can be removed when not required. In the figures shown, a step 38 is inserted into the secondary hitch receiver 24. The step 38 provides a platform for a person to stand on to access the interior of the rear vehicle. However, it should be appreciated that a trailer or any other device may be attached to the secondary hitch receiver 24 as is required. Furthermore, a ball or other hitching member may also be inserted into the secondary hitch receiver 24 attach to a device. As shown in FIG. 1, the step 38 is secured to the secondary hitch receiver 24 via a pin 34. The pin 34 is a locking member that is inserted through apertures in the secondary hitch receiver 24 and any device inserted therein. To remove the device, the pin 34 is removed and the device may be removed from the secondary hitch receiver 24.

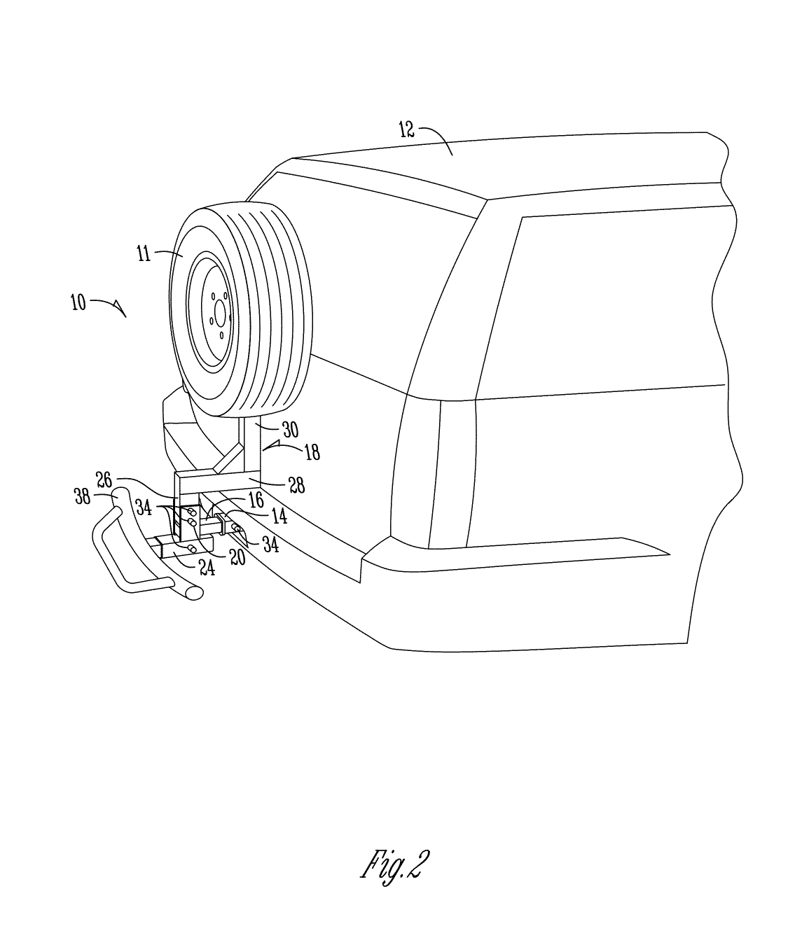

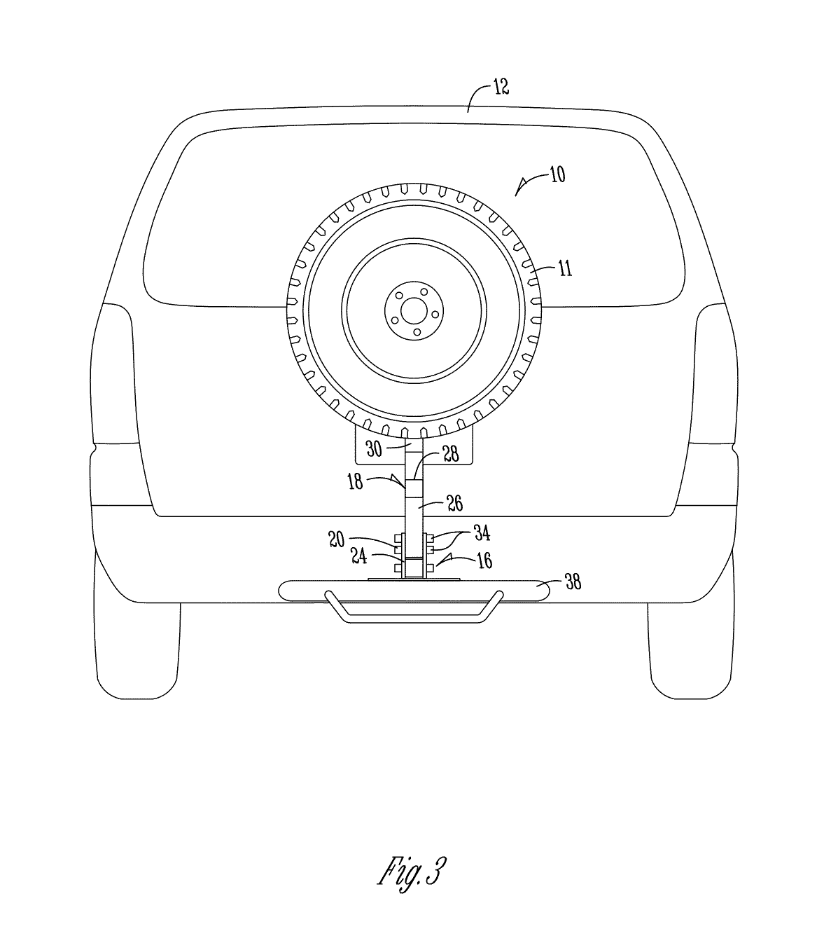

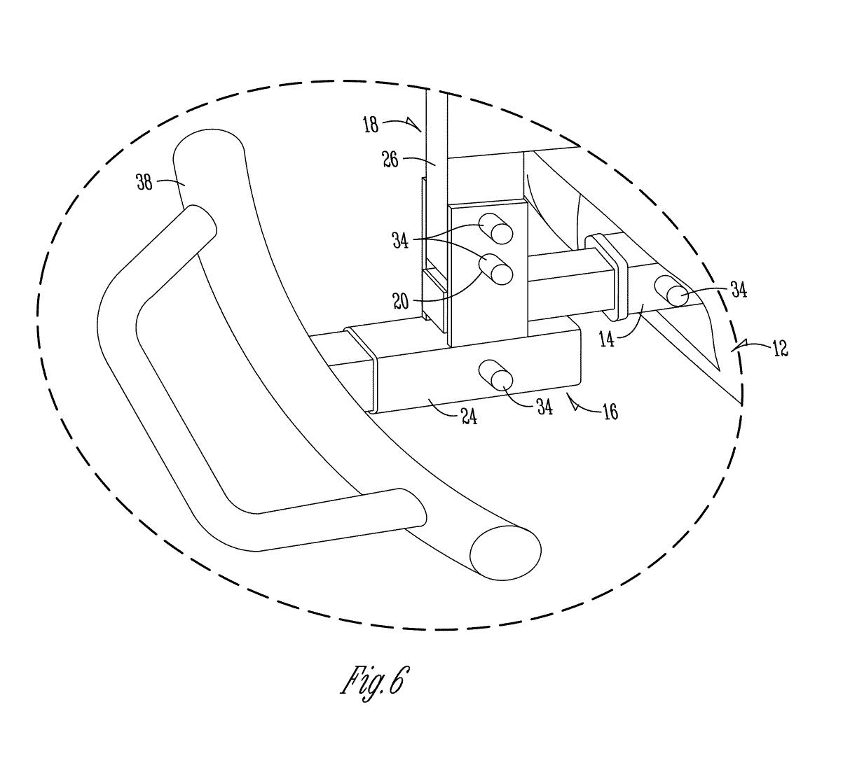

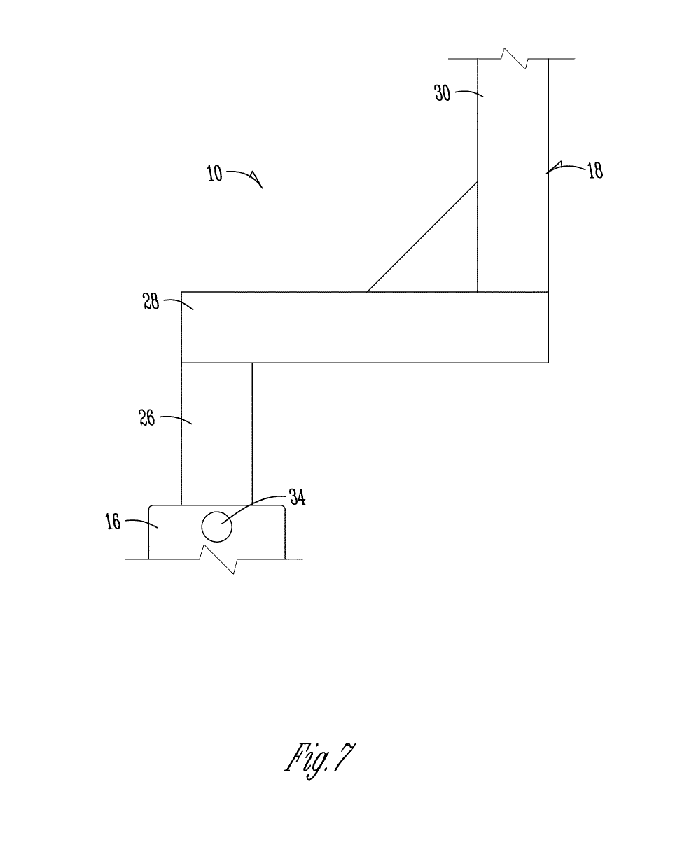

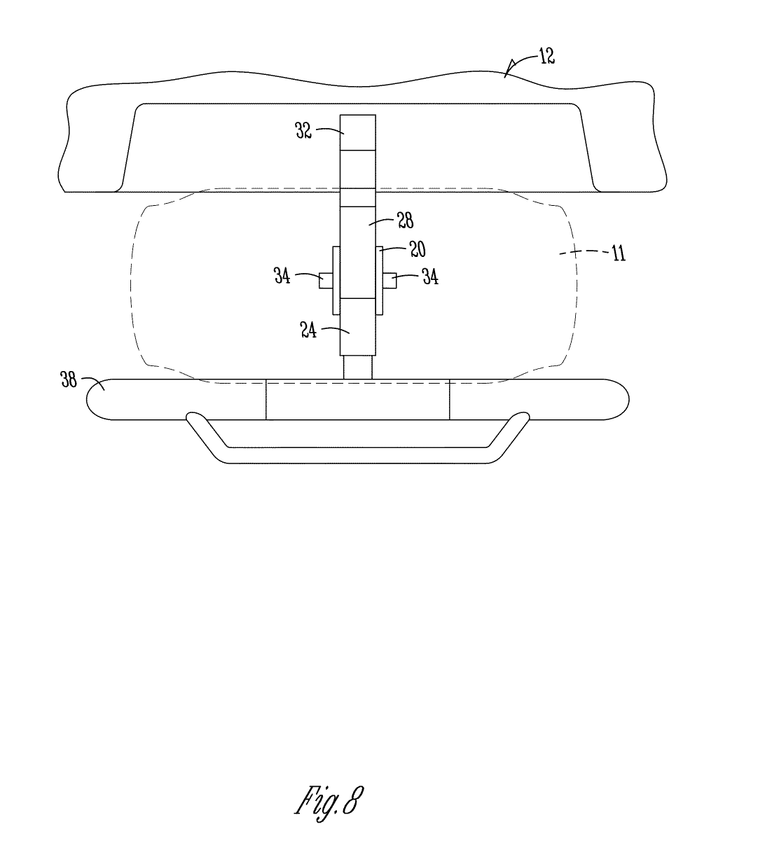

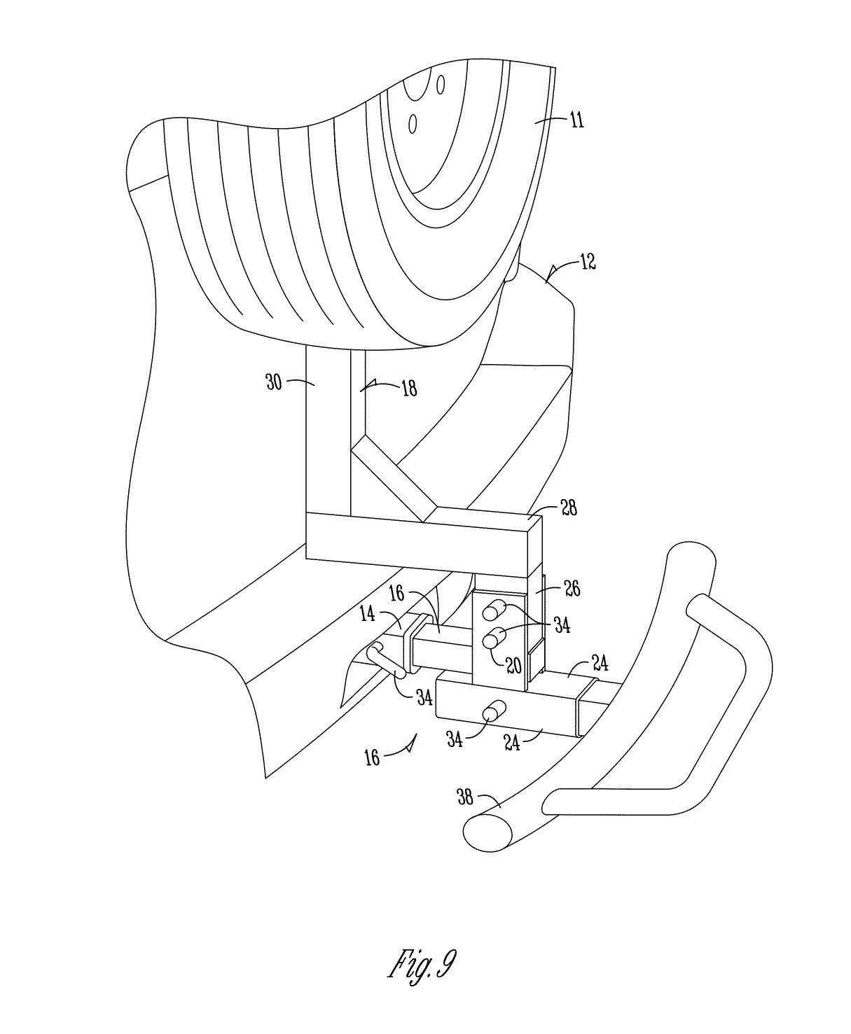

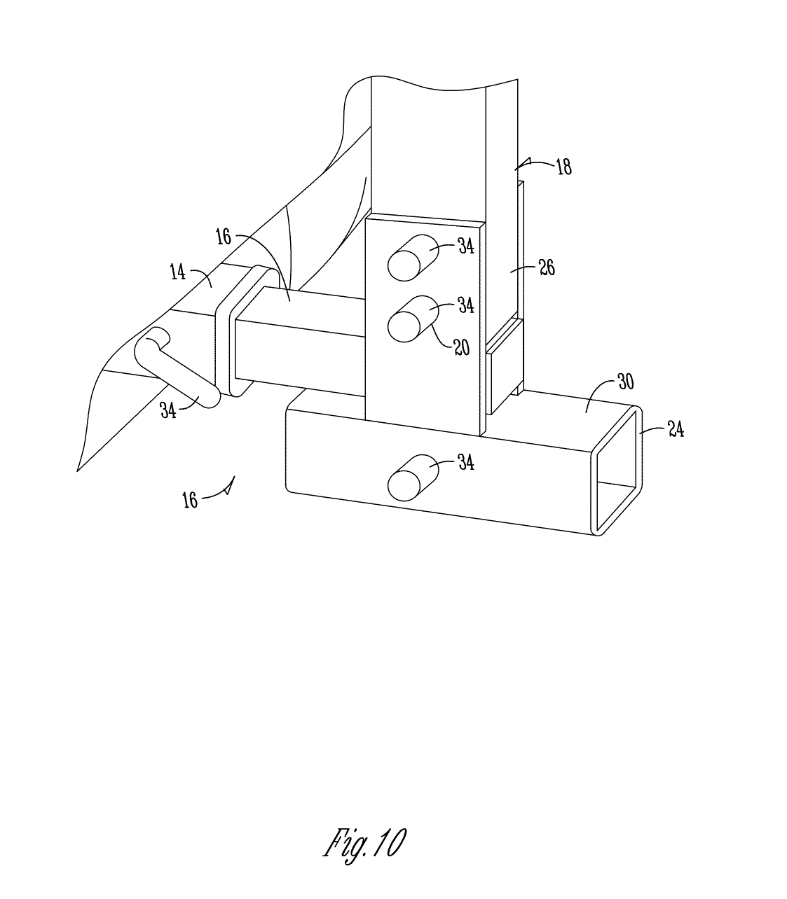

FIGS. 2-10 provide additional views of embodiments of the tire carrier 10 according to the present invention. FIGS. 2-10 show the tire carrier 10 in a variety of positions, including transport position and rotated position wherein the tire carrier 10 has rotated about the pivot point 20 to allow access to the rear door or window of the vehicle 12. The tire carrier 10 may be attached to generally any vehicle 12 having a hitch receiver 14 mounted thereon. As noted above, the tire carrier 10 replaces a spare tire 11 from within a vehicle 12, thus increasing the amount of storage space within the vehicle 12.

Use of the tire carrier 10 will now be provided. To use the tire carrier 10 of the present invention, a vehicle 12 has a hitch receiver 14 or mounting means. The hitch connector 16 is inserted into the hitch receiver 14 of the vehicle 12 and a pin 34 or other locking member is attached to the hitch connector 16 and hitch receiver 14 to hold the tire carrier 10 connected to the vehicle 12. A spare tire 11 of the vehicle 12 is then attached to the tire connector 22 of the tire carrier 10. While most vehicles utilize a standard size tire, it should be appreciated that any size tire may be connected to the tire carrier 10. Thus, if a specialized tire and rim combination is used for a vehicle 12, the spare tire 11 mounted on the tire carrier 10 may match that specialized tire size and rim. Likewise, the tire carrier 10 may include a standard size tire such that the spare tire may not be needed to be replaced for each vehicle 12 attached thereto.

When the tire has been attached to the tire carrier 10, the arm 18 of the tire carrier 10 must be positioned. If the vehicle 12 is ready to drive, the arm 18 is placed in a generally upright position and a pin 34 or other locking member is inserted through the hitch connector 16 and arm to hold the arm 18 from rotating. However, if access to the rear compartment of the vehicle 12 is required, the pin 34 may be removed and the tire carrier 10 rotated about a pivot point 20 of the hitch connector 16, which is generally a substantially horizontal axis, such that the tire carrier 10 may be rotated out of the way of the rear door, trunk, or window, such that access may be provided to the rear compartment of the vehicle 12. The tire connector 16 may be rotated up or down as required, but should be locked and placed in the upright position before transport. The carrier 10 can be rotated about the generally horizontal axis and can be configured to be stopped at generally any angle relative to the upright position. For example, some embodiments of the present invention contemplate that the carrier can be rotated greater than 90° relative to its original position, which allows access to the interior of the vehicle. In addition, there may be stops or steps to hold the carrier in place at various angles, e.g. 45°, 60°, etc., to allow for varying amounts of access to the vehicle.

Finally, if a secondary hitch receiver 24 is included in the tire carrier 10, a step 38 may be inserted thereto. However, the secondary hitch receiver 24 also allows for a trailer or other device to be attached to the secondary hitch receiver 24 such that the vehicle 12 may include the exterior spare tire 11, along with hauling a trailer. The combination of the exterior spare tire 11 and the secondary hitch receiver 24 further increases the capabilities of the tire carrier 10 and increases the storage space of the vehicle 12.

Other alternative processes obvious to those in the field of the art are considered to be included in this invention. The description is merely an example of an embodiment and limitations of the invention are not limited to the application. Many changes are considered to be part of the application. For example, the materials used for the arm 18 and other components of the tire carrier 10 may be varied. For instance, while tubular steel members have been described, it is contemplated that other shapes, sizes, and material or compositions may be included. Furthermore, while locks and pins 34 have been described to connect the components, it should be contemplated that other methods and means may be used to connect the components.

Furthermore, it is contemplated that the exact shape and color of the components of the tire carrier 10 may be varied to match the style of vehicle to which it is attached. For example, some vehicles may have a rounded design. Therefore, the portions of the arm 18 may be curved to match the contours of the shape of the vehicle 12. Other changes may be varied as well, according to the esthetic and strength requirements of the tire carrier 10.

The inventions being thus described, it will be obvious that the same may be varied in many ways. Such variations are not to be regarded as a departure from the spirit and scope of the inventions and all such modifications are intended to be included within the scope of the following claims.

The above specification provides a description of the tire carrier and use of the disclosed tire carrier. Since many embodiments can be made without departing from the spirit and scope of the invention, the invention resides in the claims.

What is claimed is:

1. A tire carrier for carrying a spare tire, comprising:
a hitch connector for connecting to a hitch receiver of a vehicle;
an arm pivotably connected to the hitch connector and extending away from the hitch connector, the arm having a tire connector at a distal end of the arm.

2. The tire carrier of claim 1, wherein the arm comprises a first portion, second portion, third portion, and fourth portion, wherein the fourth portion comprises the tire connector.

3. The tire carrier of claim 2, wherein the first portion of the arm includes apertures therethrough.

4. The tire carrier of claim 2, wherein the first, second, third, and fourth portions are welded to one another.

5. The tire carrier of claim 12, wherein the first, second, third, and fourth portions are welded at generally 90° angles.

6. The tire carrier of claim 1, wherein the arm pivots relative a generally horizontal axis.

7. The tire carrier of claim 1, wherein the hitch connector is inserted into the receiver hitch of a vehicle.

8. The tire carrier of claim 4, wherein arm pivots at least 60° relative to a generally horizontal axis.

9. The tire carrier of claim 1 further comprising a secondary hitch connected to the hitch connector, the secondary hitch comprising a receiver.

10. The tire carrier of claim 9, wherein the secondary hitch receiver includes apertures therethrough.

11. The tire carrier of claim 10, further comprising a step operably connected to the secondary hitch receiver.

12. A tire carrier for carrying a spare tire, comprising:
a hitch connector for connecting to a hitch of a vehicle;
an arm pivotably connected to the hitch connector and extending away from the hitch connector, the arm having a tire connector at a distal end of the arm, wherein the arm pivots relative a generally horizontal axis; and
a secondary hitch connected to the hitch connector, the secondary hitch comprising a receiver.

13. The tire carrier of claim 12, wherein the arm comprises a first portion, second portion, third portion, and fourth portion, wherein the fourth portion comprises a tire connector and the portions are welded to one another at generally 90° angles.

14. The tire carrier of claim 13, wherein the tire connector is configured to hold any size tire or other items.

15. The tire carrier of claim 13, further comprising support members between the portions.

16. The tire carrier of claim 13, wherein the first portion of the arm includes apertures therethrough.

17. The tire carrier of claim 16, wherein pins are inserted in the apertures.

18. The tire carrier of claim 12, wherein the secondary hitch receiver includes apertures therethrough.

19. The tire carrier of claim 18, wherein pins are inserted in the apertures.

20. A tire carrier for carrying a spare tire, comprising:
a hitch connector for connecting to a hitch of a vehicle;
an arm pivotably connected to the hitch connector and extending away from the hitch connector, the arm having a tire connector at a distal end of the arm, wherein the arm is tubular and pivots relative a generally horizontal axis, and wherein the arm comprises a first portion, second portion, third portion, and fourth portion, wherein the fourth portion comprises a tire connector; and
a secondary hitch connected to the hitch connector, the secondary hitch comprising a receiver.
